(19) United States
(12) Patent Application Publication
(10) Pub. No.: US 2026/0095035 A1
(43) Pub. Date: Apr. 2, 2026

(54) HOLDING TERMINATION FOR A PROTECTIVE SHEATH

(71) Applicant: AIRBUS HELICOPTERS, Marignane Cedex (FR)

(72) Inventors: Bernard CALABRESE, Marseille (FR); Eric JACQUEMIN, Vitrolles (FR)

(73) Assignee: AIRBUS HELICOPTERS, Marignane Cedex (FR)

(21) Appl. No.: 19/239,193

(22) Filed: Jun. 16, 2025

(30) Foreign Application Priority Data
Sep. 30, 2024 (FR) FR2410458

(51) Int. Cl. H02G 3/00; H02G 3/04

(52) U.S. Cl. CPC H02G 3/263; H02G 3/0406; H02G 3/0468

(57) ABSTRACT

A holding termination for a protective sheath, the holding termination comprising a hollow end piece having a fastening section to be connected to the protective sheath and an immobilization section integral with the fastening section. The immobilization section comprises at least two openings, the immobilization section comprising at least two separating walls each separating two adjacent openings, the holding termination comprising a first clamping tie jointly clamping a separating wall and a wired link passing through the end piece and the protective sheath.

### CROSS REFERENCE TO RELATED APPLICATION

This application claims priority to French patent application No. FR 24 10458 filed on September 30, 2024, the disclosure of which is incorporated in its entirety by reference herein.

### TECHNICAL FIELD

The present disclosure relates to a holding termination for a protective sheath, as well as to an assembly comprising such a holding termination and such a protective sheath, and to a vehicle comprising such an assembly.

### BACKGROUND

A vehicle may comprise equipment connected by wired links.

The expression "wired link" is used below to mean any connection means allowing the passage of information or energy, or even fluid, such as an electrical wired link, an optical wired link, a pneumatic wired link or a hydraulic wired link, for example.

For example, a wired link may comprise at least one electrical wire, at least one electrical cable, at least one pipe and/or at least one optical fiber.

A wired link may be arranged in a protective sheath in order to be protected from various hazards. For example, the protective sheath may be in the form of a corrugated sheath or else a convoluted sheath or a so-called circumvoluted sheath. The wired link thus passes through the protective sheath. On the other hand, the wired link projects outside the protective sheath so that it can be connected to another device. Consequently, the wired link is subject to friction with the inlet and outlet of the protective sheath.

To overcome this drawback, a first known technical solution consists in thickening the wired link using a stack of heat-shrinkable sheaths, then adding a last heat-shrinkable sheath that extends over this stack and the end of the protective sheath. This solution is effective, but gives rise to an implementation time and non-negligible financial costs and/or mass.

A second technical solution proposes screwing an end piece to each end of the protective sheath. Such an end piece comprises a protective ring integral with a threaded cylinder to be screwed to the protective sheath. The end piece is then screwed to the protective sheath until the protective sheath abuts against the ring.

Documents WO 2014/141935 A1, DE 102019116624 A1, FR 3087214 A1, EP 3713025 A1 and KR 20230032364 A are also known.

### SUMMARY

An object of the present disclosure is therefore to propose an innovative holding termination for a protective sheath in order to reduce the risk of damage to a wired link arranged in this protective sheath.

The disclosure thus relates to a holding termination for a protective sheath protecting a wired link, the holding termination comprising a hollow end piece delimiting a central channel, the end piece having an annular attachment section to be connected to the protective sheath, for example an attachment section to be screwed to the protective sheath, the end piece comprising an immobilization section integral with the attachment section. The immobilization section may be annular in shape and/or may be joined to the attachment section.

The immobilization section comprises at least two openings around the central channel each placing the central channel in fluid communication with an environment situated outside the end piece, the immobilization section comprising at least two separating walls each separating two adjacent openings, said holding termination comprising a first clamping tie for jointly clamping one of the separating walls and a wired link passing through the end piece and the protective sheath.

Therefore, the holding termination comprises an innovative end piece. The end piece extends longitudinally from a section called, for example, the "inlet section" provided in the attachment section, to a section called, for example, the "outlet section" provided in the immobilization section, delimiting a central channel connecting the inlet section to the outlet section. The end piece is further provided with bores forming radial openings facing the central channel, and therefore different from the inlet and outlet sections. Each opening passes through the end piece in a direction from the central channel towards the environment outside the end piece.

An operator can equip a protective sheath using the end piece according to the disclosure. For this purpose, the operator inserts the attachment section into one end of the protective sheath, for example until the protective sheath is in abutment against the immobilization section. This protective sheath may be a convoluted sheath, or a so-called circumvoluted sheath, or a corrugated sheath, for example. The operator can then pass a wired link through the protective sheath and the end piece, the wired link entering the end piece through a section called, for example, the "inlet section", to distinguish it from the other sections, then passing through the central channel of the end piece before leaving it through another section called, for example, the "outlet section", to distinguish it from the other sections. The operator then clamps the wired link against a separating wall of the end piece using the first clamping tie, in order to immobilize the wired link with the end piece. Such a first clamping tie may comprise, for example, a conventional clamping band or collar, such as a cable tie or the like.

As a result, this innovative holding termination tends to limit the risk of degradation by friction of the wired link against the protective sheath. The wired link is thus protected and held by the holding termination, unlike a conventional end piece.

In addition, the holding termination may reduce the implementation time, compared to a solution requiring the arrangement of multiple heat-shrinkable sheaths, and/or may have relatively low financial cost and/or mass.

The holding termination may also comprise one or more of the following features.

According to one possibility, the openings may be equally distributed around the central channel.

This feature can enable the wired link to be immobilized in multiple positions all around the central channel.

According to one possibility compatible with the preceding possibilities, the at least two openings may comprise four openings, and the at least two separating walls may comprise four separating walls.

This feature can enable the wired link to be immobilized in multiple positions all around the central channel.

According to one possibility compatible with the preceding possibilities, said holding termination may comprise a second clamping tie and a support, the second clamping tie clamping the support and a so-called separating wall, the support comprising an attachment piece.

Such a second clamping tie may comprise, for example, a conventional clamping band or collar, such as a cable tie or the like.

The support may extend partially in line with the end piece so that the attachment piece is easily accessible. For example, such an attachment piece may include a pierced plate that may be screwed to a structure.

Thus, the support may enable the holding termination to provide additional mechanical support to the protective sheath.

According to one possibility compatible with the preceding possibilities, the holding termination may comprise a first flange and a second flange on either side of a central ring, the central ring comprising said openings and said separating walls.

Each separating wall then extends from the first flange to the second flange.

Optionally, the central ring has a third diameter smaller than a first diameter of the first flange and than a second diameter of the second flange.

The size of the holding termination can be optimized, with at least a portion of the first clamping tie being able to be housed between the flanges.

For example, at least one flange has a diameter substantially equal to the diameter of the protective sheath to be equipped.

If a support as described above is present, the support may be in contact with the first flange and the second flange.

Thus, the support is correctly secured to the end piece by the second clamping tie.

According to one possibility compatible with the preceding possibilities, the attachment section may comprise a screw thread.

The attachment section can then be screwed to the protective sheath, optionally inside the protective sheath.

Furthermore, the disclosure also relates to an assembly provided with a holding termination as described above and with a protective sheath through which a wired link passes, the attachment section being connected, and for example screwed, to the protective sheath, the first clamping tie clamping the wired link to the separating wall.

Optionally, the protective sheath may be in abutment against the immobilization section.

Such an assembly can be arranged on any system comprising a wired link disposed in a protective sheath.

For example, the disclosure also relates to a vehicle comprising such an assembly. This vehicle may be an aircraft, a motor vehicle, a ship, etc.

### BRIEF DESCRIPTION OF THE DRAWINGS

The disclosure and its advantages appear in greater detail from the following description of examples given by way of illustration with reference to the accompanying figures, wherein:

FIG. 1 is an exploded view of a holding termination according to the disclosure; and

FIG. 2 is a view of an assembly according to the disclosure.

### DETAILED DESCRIPTION

Elements present in more than one of the figures are given the same reference signs in each of them.

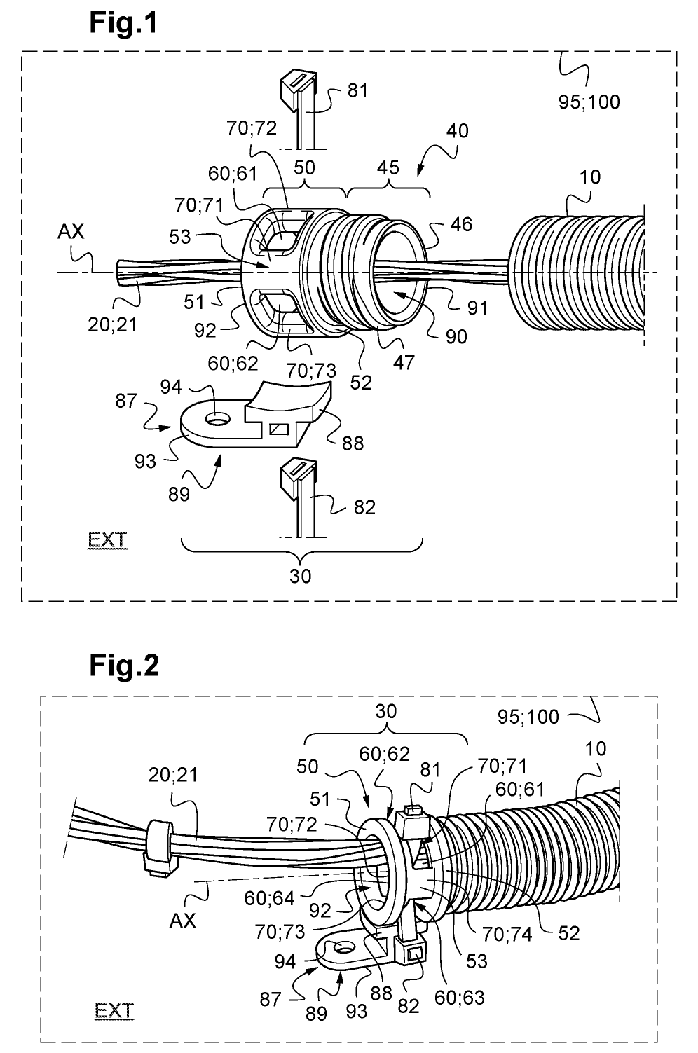

FIG. 1 shows an assembly 95 having a protective sheath 10 through which a wired link 20 passes. The protective sheath may be a convoluted sheath or a corrugated sheath, for example. According to the example given, this wired link 20 may comprise one or more electrical wires 21. However, the wired link 20 may alternatively or additionally comprise at least one cable, at least one optical fiber and/or at least one pipe.

The assembly 95 may be disposed within any type of system, and for example within a vehicle or even, in particular, within an aircraft.

Independently of these aspects, such an assembly 95 comprises a holding termination 30 according to the disclosure. An example of this holding termination 30 is shown in exploded form in FIG. 1, and another example is shown in assembled form in FIG. 2.

Regardless of the embodiment and with reference to FIG. 1, such a holding termination 30 comprises an end piece 40 delimiting a central channel 90. The central channel 90 extends along its length, for example along an axis of symmetry AX, from an inlet section 91 of the end piece to an outlet section 92 of the end piece.

The end piece 40 comprises an attachment section 45 integral with an immobilization section 50, that are optionally annular in shape to delimit the central channel 90.

The function of the attachment section 45 is to connect the end piece 40 to the protective sheath 10. The attachment section 45 therefore comprises the inlet section 91. This attachment section 45 may be annular in shape and pushed into the protective sheath 10. This attachment section 45 may be in the form of a rotationally symmetric cylinder.

The attachment section 45 may comprise a screw thread to be screwed to the protective sheath 10. Thus, the attachment section 45 illustrated comprises a cylinder 46 carrying a thread 47 forming a screw thread capable of being screwed to the protective sheath 10. The cylinder 46 may include a chamfer at the inlet section of the end piece.

The immobilization section 50 extends the attachment section 45, for example along the axis AX. Optionally, the immobilization section may be straight or curved. The immobilization section 50 comprises the outlet section 92. The immobilization section 50 may be annular in shape. For example, the immobilization section 50 and the attachment section 45 are concentric.

Furthermore, the immobilization section 50 comprises at least two openings 60 situated around the central channel 90, and, for example, between the inlet and outlet sections. Each opening places the central channel 90 in fluid communication with an environment EXT situated outside the end piece and the protective sheath. Reference sign 60 designates any opening, and reference signs 61 to 64 designate specific openings if necessary.

In addition, the immobilization section 50 includes at least two separating walls 70, each separating wall 70 separates two adjacent openings 60 in a direction tangential to the central channel. Reference sign 70 designates any separating wall, and reference signs 71 to 74 designate specific separating walls, if necessary.

Optionally, the openings 60 and/or the separating walls 70 are equally distributed around the central channel 90.

According to the examples of FIGS. 1 and 2, the end piece 40 comprises four openings 61, 62, 63, 64, and therefore four separating walls 71, 72, 73, 74.

The openings 60 may be disposed in a central ring 53 of the immobilization section 50, this central ring 53 being disposed between a first flange 51 comprising the outlet section 51 and a second flange 52 of the immobilization section 50. Each separating wall 71, 72, 73, 74 then comprises one end connected to the first flange 51 and another end connected to the second flange 52.

The second flange 52 is then attached to the attachment section 45 and can act as a stop for the protective sheath 10.

According to the example in FIG. 1, the central ring 53 has a third outer diameter equal to a first outer diameter of the first flange 51 and to a second outer diameter of the second flange 52. In other words, the immobilization section 50 is in the form of a radially pierced rotationally symmetric cylinder.

According to the example in FIG. 2, the central ring 53 has a third diameter smaller than a first diameter of the first flange 51 and than a second diameter of the second flange 52.

Furthermore, and with reference to FIG. 2 for example, the holding termination 30 further comprises a first clamping tie 81. In use, the first clamping tie 81 passes through two adjacent openings 61, 62 to jointly clamp the associated dividing wall 71 and the wired link 20 passing through the end piece 40 and the protective sheath 10. The wired link 20 is thus immobilized with respect to the protective sheath 10 at the end piece 40.

In one possibility, the holding termination 30 may include an additional holding system for immobilizing the protective sheath 10 and the wired link 20 relative to a supporting structure.

Thus, the holding termination 30 may comprise a second clamping tie 82 securing a support 89 to the immobilization section 50. In particular, the second clamping tie 82 can pass through two openings 63, 64 in order to jointly clamp a separating wall 74 and the support 89.

For example, the support 89 may comprise a base 88 shaped to the first flange 51 and to the second flange 52, so as to be joined against this first flange 51 and this second flange 52. Optionally, the base 88 may include a bore through which the second clamping tie 82 may pass.

In addition, the support 89 may comprise an attachment piece 87 for attaching the support 89 to a support structure. For example, such an attachment piece 87 comprises a plate 93 integral with the base 88. This plate 93 is advantageously pierced in order to be able to present an orifice 94 allowing it to be secured by screwing, for example, to the supporting structure.

Naturally, the present disclosure may be subjected to numerous variations as to its implementation. Although several embodiments are described above, it should readily be understood that it is not conceivable to identify exhaustively all the possible embodiments. It is of course possible to replace any of the means described with equivalent means without going beyond the ambit of the present disclosure.

WHAT IS CLAIMED IS:

1. A holding termination for a protective sheath protecting a wired link, the holding termination comprising a hollow end piece delimiting a central channel, the end piece having an annular attachment section to be connected to the protective sheath, the end piece comprising an immobilization section integral with the attachment section,
wherein the immobilization section comprises at least two openings around the central channel, each opening placing the central channel in fluid communication with an environment situated outside the end piece, the immobilization section comprising at least two separating walls, each separating walls separating two adjacent openings, the holding termination comprising a first clamping tie for jointly clamping a separating wall and a wired link passing through the central channel of the end piece and the protective sheath.

2. The holding termination according to claim 1,
wherein the openings are equally distributed around the central channel.

3. The holding termination according to claim 1,
wherein the at least two openings comprise four openings, the at least two separating walls comprising four separating walls.

4. The holding termination according to claim 1,
wherein the holding termination comprises a second clamping tie and a support, the second clamping tie clamping the support and a separating wall, the support comprising an attachment piece.

5. The holding termination according to claim 1,
wherein the holding termination comprises a first flange and a second flange on either side of a central ring, the central ring comprising the openings and the separating walls.

6. The holding termination according to claim 4,
wherein the holding termination comprises a first flange and a second flange on either side of a central ring, the central ring comprising the openings and the separating walls and wherein the support is in contact with the first flange and the second flange.

7. The holding termination according to claim 5,
wherein the central ring has a third diameter, smaller than a first diameter of the first flange and then a second diameter of the second flange.

8. The holding termination according to claim 1,
wherein the attachment section has a screw thread.

9. An assembly provided with the holding termination and a protective sheath through which a wired link passes,
wherein the holding termination is according to claim 1, the attachment section being connected to the protective sheath, the first clamping tie clamping the wired link to the separating wall.

10. The assembly according to claim 9,
wherein the protective sheath is in abutment against the immobilization section.

11. A vehicle,
wherein the vehicle comprises the assembly according to claim 9.
